(19) United States
(12) Patent Application Publication
(10) Pub. No.: US 2026/0248081 A1
(43) Pub. Date: Aug. 27, 2026

(54) ADJUSTABLE VINE CROP SUPPORT DEVICE

(71) Applicant: Robert J. Torcellini, Eastford, CT (US)

(72) Inventor: Robert J. Torcellini, Eastford, CT (US)

(21) Appl. No.: 19/064,160

(22) Filed: Feb. 26, 2025

(51) Int. Cl. A01G 9/12; B65H 75/44

(52) U.S. Cl. CPC A01G 9/126; B65H 75/4428; B65H 2403/47; B65H 2701/358

(57) ABSTRACT

A plant support device, includes a spool configured to adjustably store and dispense a plant support string; an escapement mechanism operatively connected to the spool and configured to control a release and retraction of the plant support string; and a latch mechanism configured to secure the plant support device to a supporting structure or wire.

### BACKGROUND OF THE INVENTION

### Field of the Disclosure

The present disclosure generally relates to devices for fastening plants, and more particularly, to a device for fastening plant material, such as vines, and the like, in a vertical manner, and the like.

### Discussion of the Background

In recent years, various agricultural and horticultural settings employ the use of support structures, such as trellises, nets, strings, or cables to support plant materials. Plants with varying architecture, such as vining and indeterminate plants, such as tomatoes, cucumbers, and certain melons, frequently require support structures. The primary devices employed for supporting such plants are spools or bobbins with a hook which is used to attach to an overhead support structure. As the vine grows, it is necessary to lower the plant elevation so that the plant doesn't grow into a ceiling area, and so as to provide safer and easier access for the operator.

### SUMMARY OF THE DISCLOSURE

Therefore, there is a need for devices that address the above and other problems. The above and other problems are addressed by the illustrative embodiments of the present disclosure, where there is provided a crop support device that can, for example, be constructed of plastic, other suitable materials, and the like. The device can be hooked and suspended from a support wire, and employ a containment latch mechanism, and the like, advantageously, preventing the device from accidental removal, and the like. Throughout the plant growth cycle, the device further includes an advantageous mechanism that allows the operator to safely extend supporting string from a spool while concurrently lowering attached vegetation. The device further includes a mechanism to limit spool rotation, advantageously, preventing the spool from accidental release, and the like, of excess string. The device includes a rewinding mechanism, advantageously, allowing the operator to rewind and raise the attached vegetation.

Accordingly, in illustrative aspects of the present disclosure there is provided a plant support device, including a spool configured to adjustably store and dispense a plant support string; an escapement mechanism operatively connected to the spool and configured to control a release and retraction of the plant support string; and a latch mechanism configured to secure the plant support device to a supporting structure or wire.

The plant support device of claim 1, wherein the escapement mechanism resists the unwinding of the plant support string due to gravitational force unless a user actively engages the escapement mechanism to release the plant support string.

The plant support device of claim 1, wherein the spool comprises one or more ratchet teeth configured to engage with the escapement mechanism.

The plant support device of claim 1, wherein the escapement mechanism and the spool comprise a ratchet system, the ratchet system configured to selectively permit the spool to rotate in a first direction while restricting rotation in an opposite direction, thereby controlling the release and retraction of the plant support string.

The plant support device of claim 1, wherein the spool comprises a groove formed at a barrel of the spool, and configured to guide and retain the plant support string, preventing the plant support string from slipping off the spool during use.

The plant support device of claim 1, wherein the spool further comprises one or

more slots configured to allow placement of the plant support string to prevent the plant support string from unwinding when the spool is not within the plant support device.

The plant support device of claim 1, wherein the spool further comprises a winding hub configured to integrate with an external mechanical winding apparatus.

The plant support device of claim 1, wherein the spool further comprises a hand-winding knob configured to allow a user to manually rotate the spool to wind the plant support string onto the spool.

The plant support device of claim 1, wherein the spool is removable from the plant support device to allow for winding, replacement, or adjustment of the plant support string length.

The plant support device of claim 1, wherein the spool is mounted on a central axis and is removable by sliding through slots in a body of the plant support device, the escapement mechanism creating a pinch point that must be overcome to insert or remove the spool.

The plant support device of claim 1, wherein the latch mechanism includes a hook portion incorporated therein and configured to attach to the supporting structure or wire and ensure the plant support device remains securely attached.

The plant support device of claim 1, wherein the latch mechanism is configured to engage by a force of gravity, automatically securing plant support device to the supporting structure or wire, and so as to prevent accidental detachment.

The plant support device of claim 3, wherein the escapement mechanism comprises a dual cog system configured to provide redundant engagement with the one or more ratchet teeth of the spool to enhance safety and prevent unintended release.

The plant support device of claim 1, wherein the latch mechanism further comprises a secondary locking mechanism configured to engage with the supporting structure or wire to further prevent accidental detachment.

The plant support device of claim 5, wherein the spool further comprises a pair of spool flanges extending outward from the barrel to retain the plant support string and prevent lateral displacement.

The plant support device of claim 15, wherein the spool flanges further comprise spool edges configured to provide additional retention of the plant support string and reduce a likelihood of slipping.

The plant support device of claim 7, wherein the winding hub further comprises a hex attachment point configured to interface with a standard winding tool for efficient manual rewinding of the plant support string, and the device is constructed with corrosion-resistant fasteners, including at least one of galvanized steel, stainless steel, hot metal riveting, adhesives, and sonic welding.

The plant support device of claim 1, wherein the latch mechanism further comprises a pivotally mounted containment latch configured to automatically engage the supporting structure or wire and remain in a locked position until manually released by a user.

The plant support device of claim 1, wherein the escapement mechanism is configured to selectively allow a controlled amount of slack in the plant support string, the controlled amount slack enabling height adjustments of a supported plant.

The plant support device of claim 1, wherein the spool further comprises at least one notched catchment configured to secure an end of the plant support string in a fixed position when not in use.

Still other aspects, features, and advantages of the present disclosure are readily apparent from the following detailed description, by illustrating a number of illustrative embodiments and implementations, including the best mode contemplated for carrying out the present disclosure. The present disclosure is also capable of other and different embodiments, and its several details can be modified in various respects, all without departing from the spirit and scope of the present disclosure. Accordingly, the drawings and descriptions are to be regarded as illustrative in nature, and not as restrictive.

### BRIEF DESCRIPTION OF THE DRAWINGS

The embodiments of the present disclosure are illustrated by way of example, and not by way of limitation, in the figures of the accompanying drawings and in which like reference numerals refer to similar elements and in which:

FIG. 1 is a front-right perspective view of a crop support device attached to a support cable;

FIG. 2 is a rear-left perspective view of the crop support device of FIG. 1;

FIG. 3 is an exploded front-right perspective view of the crop support device of FIG. 1;

FIG. 4 is a section view of the crop support device of FIG. 1 with a string and an escapement lever in a normal position;

FIG. 5 is a section view of the crop support device of FIG. 1 with the string and the escapement lever in a release position;

FIG. 6 is a side view of the crop support device of FIG. 1 with a spool at a removal point where an escapement mechanism provides resistance to removal of the spool;

FIG. 7 is a perspective view of the spool of the crop support device of FIG. 1 without the string;

FIG. 8 is a perspective view of the spool of the crop support device of FIG. 1 with a knotted portion of the string placed into a notched catchment;

FIG. 9 is a perspective view of the spool of the crop support device of FIG. 1 with the string fixed within the notched catchment;

FIG. 10 is a top view of the spool of the crop support device of FIG. 1 without the string;

FIG. 11 is a section view of the crop support device of FIG. 1 in a process of being attached to a supporting wire with a containment latch in an open position; and

FIG. 12 is a section view of the crop support device of FIG. 1 attached to the supporting wire with the containment latch in a closed position.

### DETAILED DESCRIPTION OF THE PREFERRED EMBODIMENTS

The following detailed description and accompanying drawings are intended as descriptions of various embodiments of the disclosure and are not intended to represent the only embodiments. Each embodiment described in this disclosure is intended to describe aspects of the disclosure in sufficient detail to enable those skilled in the art to practice the disclosure. Other embodiments can be utilized, and changes can be made without departing from the scope of the present disclosure. The illustrative examples provided herein are not intended to be exhaustive or to limit the claimed subject matter to the precise forms disclosed. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated, as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The articles “a” and “an”, used here, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or features, and may have a single or plural connotation depending upon the context in which it is used. The adjective “any” means one, some, or all indiscriminately or whatever quantity.

Reference Numeral Table for Drawings

| Reference Numeral | Component Name |
|---|---|
| 100A, 100B | Device Body |
| 101 | Hook |
| 102 | Latch Pivot |
| 103 | Lower Latch Indent |
| 104 | Upper Latch Indent |
| 105 | Spool Axle Channel |
| 105A | Spool Axle Channel (right) |
| 105B | Spool Axle Channel (left) |
| 106 | Axle Pinch Point |
| 107 | Pivot Point |
| 108 | String Guide |
| 200 | Escapement Lever |
| 201 | Escapement Lever Pinch Point |
| 202 | Front Escapement & Ratchet Contact |
| | Point |
| 203 | Rear Escapement & Ratchet Contact Point |
| 205 | String/Lever Engagement Area |
| 206 | Pawl |
| 300 | Spool |
| 301A | Spool Axle (right) |
| 301B | Spool Axle (left) |
| 302 | Spool Edge |
| 303 | Auxiliary Winding Hub |
| 304 | Barrel Groove |
| 305 | Ratchet Tooth |
| 306 | String Catchment Grooves |
| 307 | Hand Winding Knob |
| 308 | Spool Barrel |
| 309 | Spool Flange |
| 400 | Containment Latch |
| 401 | Latch Tab |
| 901 | Supporting Wire |
| 902 | Plant Support String |
| 903 | String Knot |

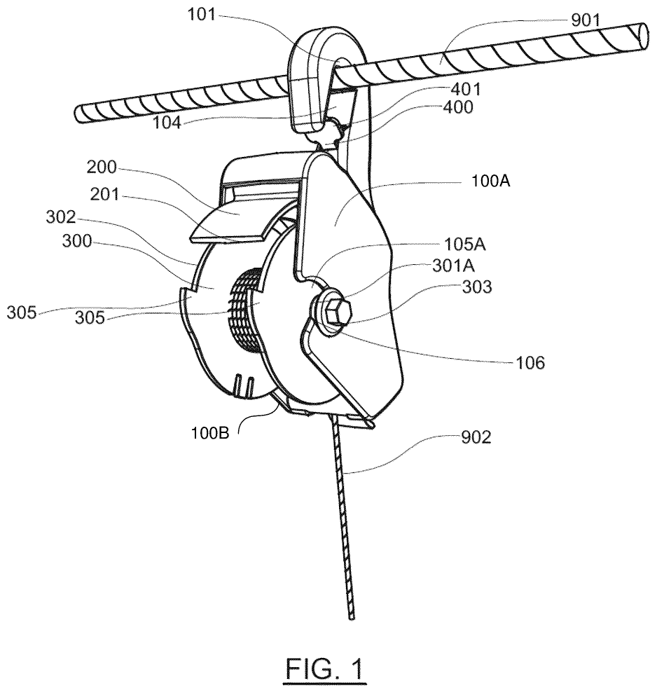

Referring now to the drawings, wherein like reference numerals designate identical or corresponding parts throughout the several views, and more particularly to FIG. 1 thereof, there is shown a front-right perspective view of a crop support device attached to a support cable 901. In FIG. 1, the crop support device includes device body sections 100A and 100B, and a hook 101, which advantageously facilitates suspension from the support cable 901. Advantageously, the device body sections 100A and 100B can be integrated as a single body component using any suitable techniques (e.g., 3D printing, plastic injection molding, etc.), and the like.

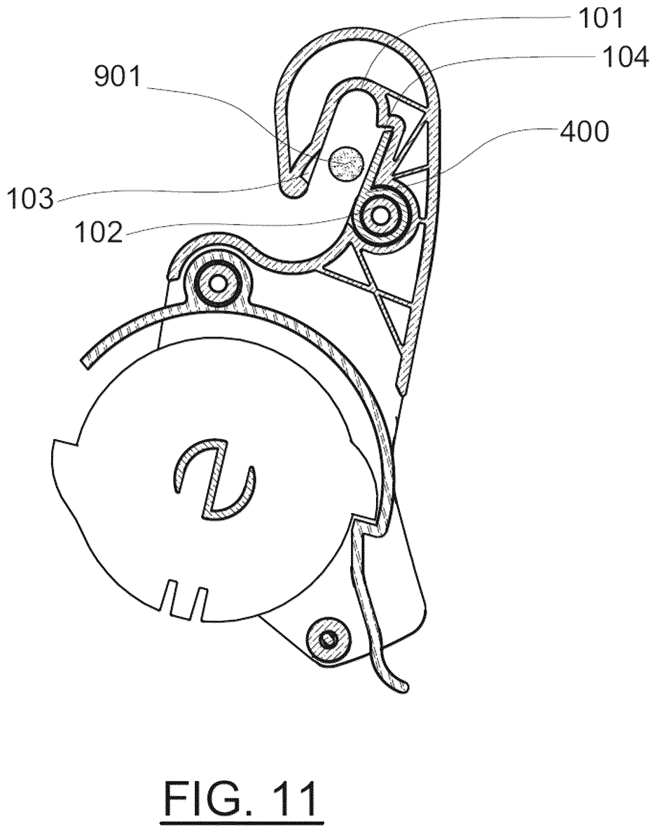

The hook 101 has a predetermined hook radius (e.g., about 7 mm, etc.), and the like, advantageously, optimizing secure attachment to the supporting wire 901 while allowing for easy installation and removal, and the like. A containment latch 400 pivots about a pivot point 102 and engages an upper latch indent 104 when positioned on the supporting wire 901, advantageously securing the crop support device in place. A lower latch indent 103 is provided to further reduce the likelihood of accidental detachment. A latch tab 401 allows an operator to rotate the containment latch 400, permitting controlled removal from the support cable 901, as further described in FIG. 11. The supporting wire 901, advantageously can be made from metal (e.g., galvanized steel, stainless steel, hot metal riveting, adhesives, sonic welding, etc.), to provide a durable and corrosion-resistant structure for securing the crop support device.

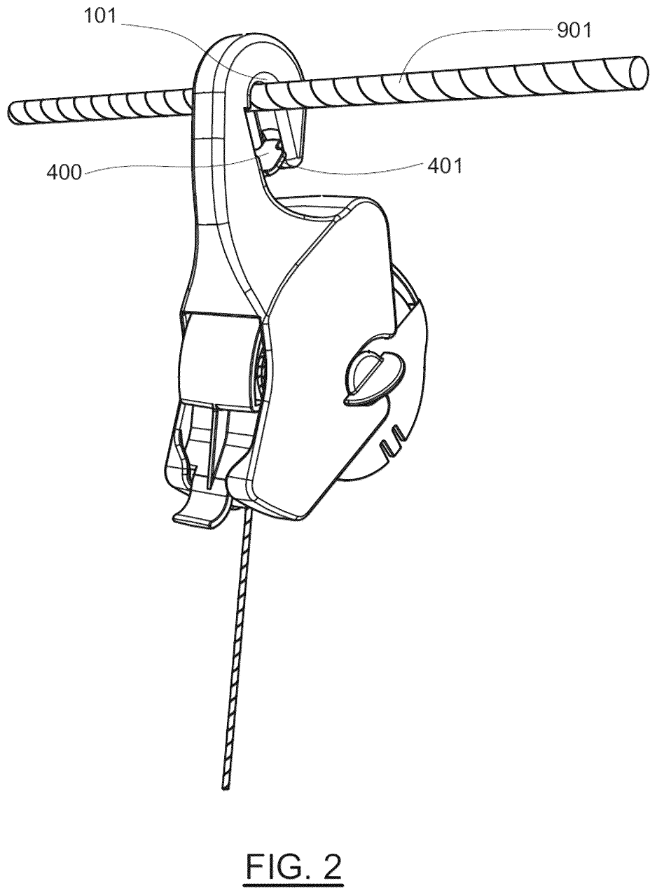

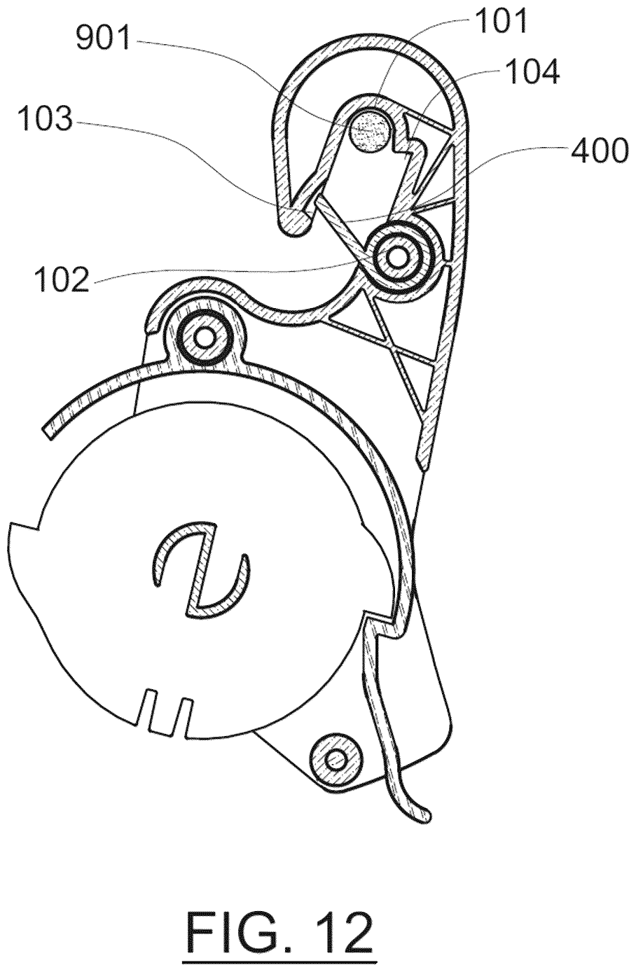

FIG. 2 is a rear-left perspective view of the crop support device of FIG. 1. In FIG. 2, the containment latch 400 and its engagement with the upper latch indent 104 are shown from an alternate angle, providing a clear view of the device's attachment mechanism. The containment latch 400 advantageously maintains secure placement on the supporting wire 901 while allowing easy removal when manipulated via the latch tab 401, as further described in FIG. 12.

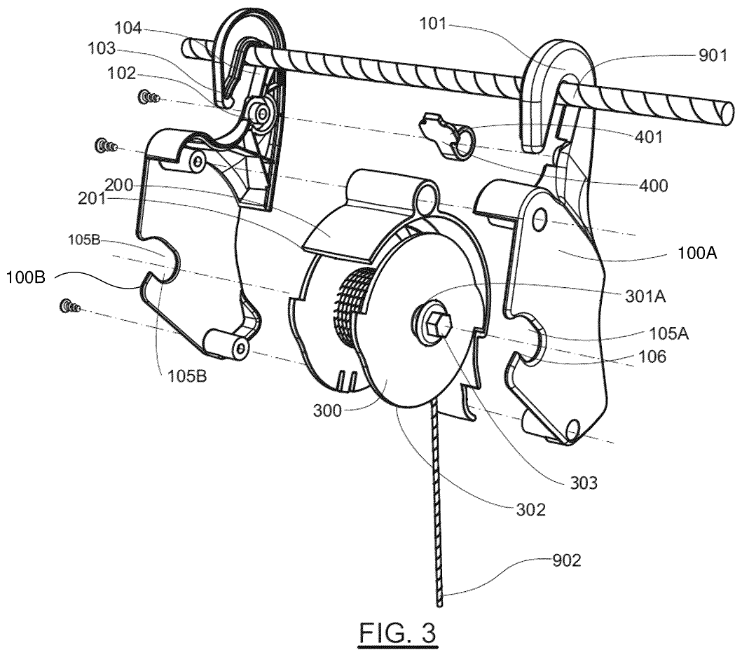

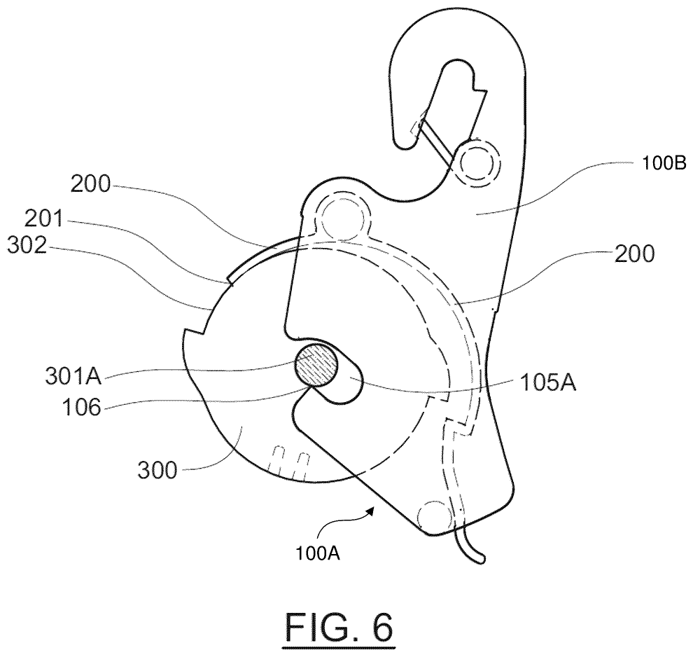

FIG. 3 is an exploded perspective view of the crop support device. In FIG. 3, a spool 300, configured to store a plant support string 902, is positioned within an axle pinch point 106 and an escapement lever pinch point 201. The spool axle 301A is spaced at a distance greater than the escapement lever pinch point 201 and the axle pinch point 106, advantageously preventing unintentional disengagement from the device body sections 100A and 100B. The escapement lever 200 flexes in response to applied force, advantageously allowing insertion or removal of the spool 300 past the pinch points 201 and 106, as further described in FIG. 6.

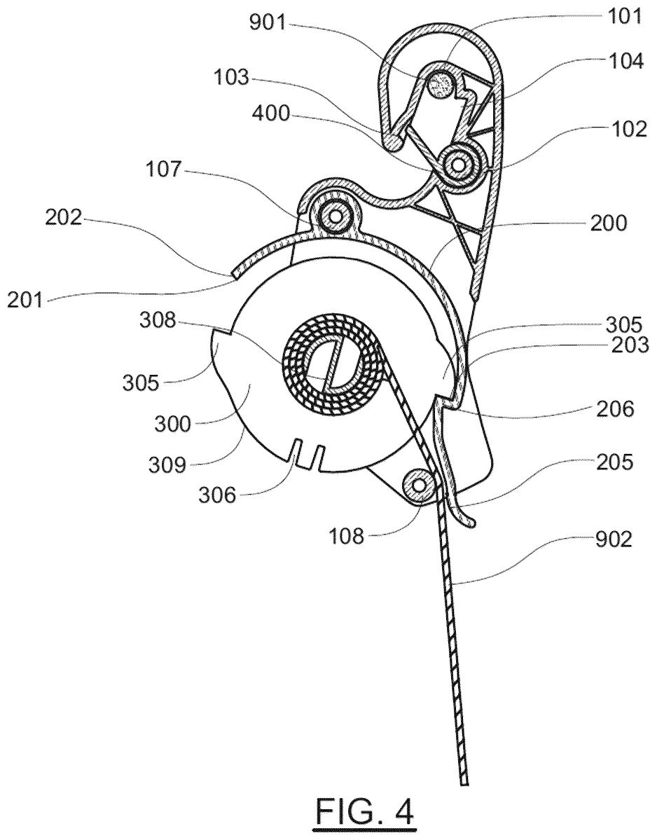

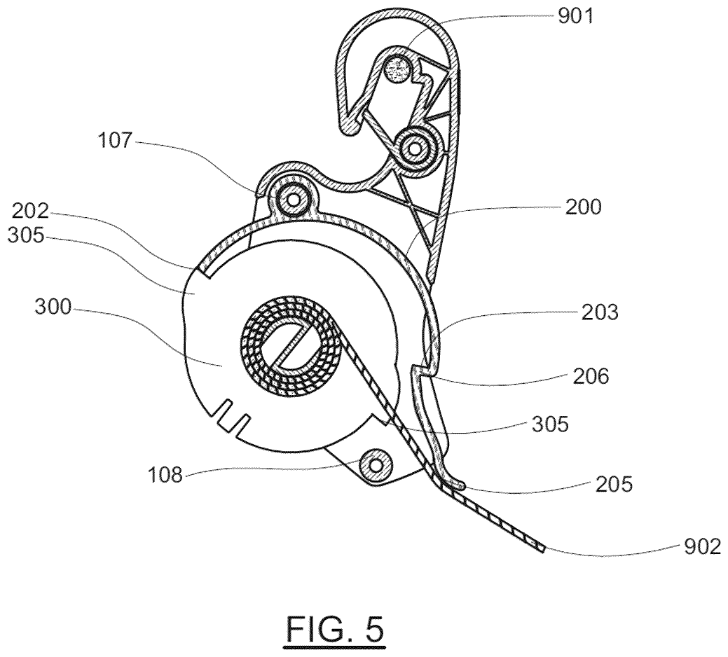

FIG. 4 is a sectional view of the crop support device with the plant support string 902 and escapement lever 200 in a normal position. In FIG. 4, the escapement lever 200 is pivotally secured to the crop support device at a pivot point 107, advantageously maintaining engagement with the string guide 108 when in a resting state. The plant support string 902 extends from the spool 300 and passes through the string guide 108 before reaching a lever engagement area 205. Downward tension on the plant support string 902 transfers rotational energy to the spool 300, advantageously allowing controlled unwinding. A ratchet tooth 305 engages a ratchet contact point 203 on the escapement lever 200, advantageously limiting the spool 300 from continuous rotation, as further described in FIG. 5.

FIG. 5 is a sectional view of the crop support device with the plant support string 902 and escapement lever 200 in a release position. In FIG. 5, the operator releases tension from the plant support string 902, shifting the string position toward the string/lever engagement area 205, which pivots the escapement lever 200 and advantageously disengages the ratchet tooth 305 from an escapement lever pawl 206. The spool 300 rotates until the ratchet tooth 305 re-engages with the front contact point 202, allowing a controlled unwinding cycle to complete. This toggling action advantageously prevents continuous rotation and reduces the risk of unintentional plant support string 902 unwinding.

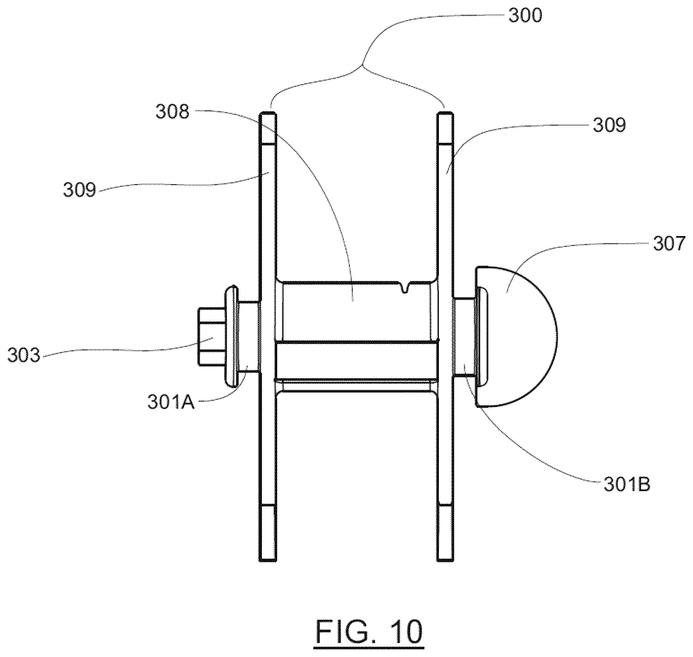

FIG. 6 is a sectional view of the crop support device at the spool removal point. In FIG. 6, the spool 300 is positioned in spool axle channel 105 having spool axle channels 105A and 105B, which correspond to the different diameters of the spool axles 301A and 301B. The variation in axle diameters advantageously ensures proper alignment during installation and reduces the likelihood of incorrect insertion, as further described in FIG. 10.

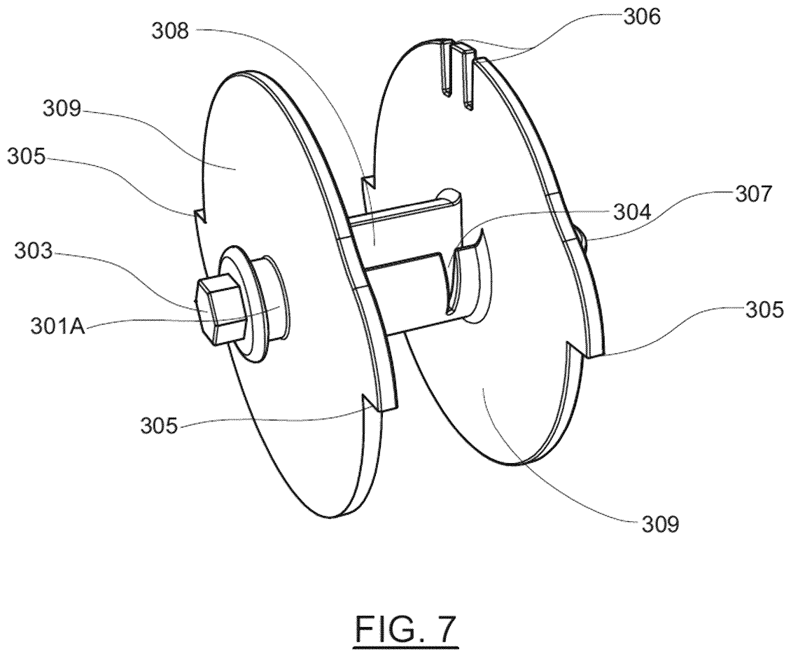

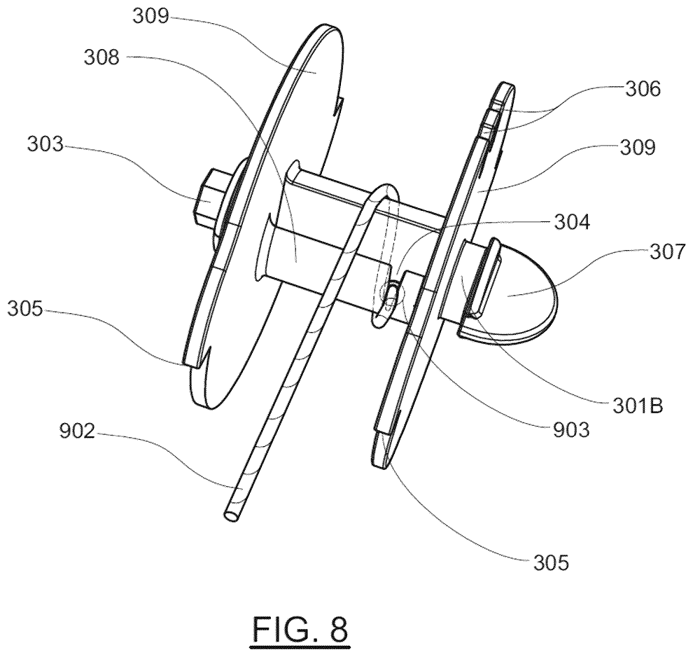

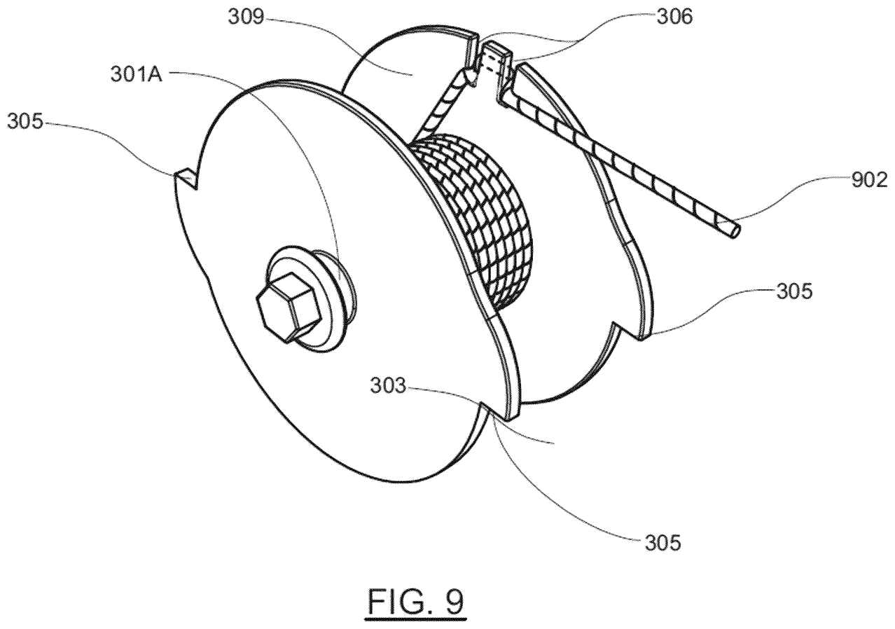

FIG. 7 is a perspective view of the spool 300 without the plant support string 902. In FIG. 7, the spool 300, advantageously made from molded plastic (e.g., injection-molded polymer), includes a barrel 308 and spool flanges 309 extending from each end of the barrel 308. Each spool flange 309 advantageously incorporates at least one ratchet tooth 305, positioned to engage a front escapement lever contact point 202 or a rear escapement lever contact point 203, as further described in FIG. 8. The spool edge 302 is positioned along the outer boundary of the spool flanges 309, advantageously preventing the plant support string 902 of FIG. 9 from slipping off during operation. Located at the center rotational point of each spool flange 309, the spool axles 301A and 301B facilitate rotation within the crop support device.

FIG. 8 is a perspective view of the spool 300 with a knotted portion of the plant support string 902 placed into a notched catchment. In FIG. 8, an auxiliary winding hub 303, positioned at the center rotational point, advantageously allows for efficient mechanical winding of the plant support string 902 prior to installation. The auxiliary winding hub 303 includes a hex attachment (e.g., about a ¼″ hex attachment, etc.), and the like, enabling the use of a standard hex tool for convenient rewinding. A hand-winding knob 307, consisting of two substantially parallel faces, advantageously enables manual rotation of the spool 300 while installed in the crop support device. The integrated winding knob 307 reduces the need to remove the spool 300 for rewinding, as further described in FIG. 9.

FIG. 9 is a perspective view of the spool 300 with the plant support string 902 fixed within a catchment. In FIG. 9, a barrel groove 304 is provided within the spool barrel 308, advantageously securing the plant support string 902 when wrapped around the spool 300. A string knot 903, ferrule, or similar structure, positioned near the end of the plant support string 902, advantageously prevents detachment from the spool 300. The spool flange 309 includes two string catchment grooves 306, through which the plant support string 902 is routed to create friction and advantageously reduce the likelihood of unintended unwinding.

FIG. 10 is a top view of the spool 300 without the plant support string 902. In FIG. 10, the barrel groove 304 is positioned along the spool barrel 308, advantageously securing the plant support string 902 while preventing slippage, as further described in FIG. 9.

FIG. 11 is a sectional view of the crop support device in the process of being attached to the supporting wire 901. In FIG. 11, the containment latch 400 pivots around the pivot point 102, advantageously enabling placement of the supporting wire 901 into the hook 101. The containment latch 400 aligns with the upper latch indent 104, advantageously stabilizing the crop support device in preparation for suspension, as further described in FIG. 12.

FIG. 12 is a sectional view of the crop support device attached to the supporting wire 901. In FIG. 12, gravitational force advantageously rotates the containment latch 400 into engagement with the lower latch indent 103, thereby enhancing retention and reducing the likelihood of detachment. The containment latch 400 remains engaged unless intentionally rotated by an operator, advantageously securing the crop support device in place during use.

Advantageously, corrosion-resistant fasteners (e.g., galvanized steel, stainless steel, hot metal riveting, adhesives, sonic welding, etc.) can be used throughout the assembly, as needed, to enhance structural integrity and durability, ensuring reliable performance under various environmental conditions.

Advantageously, the various components of the crop support device can be manufactured using any suitable techniques, for example, 3D printing, plastic injection molding, and the like.

While the present disclosure has been described in connection with a number of illustrative embodiments, and implementations, the present disclosure is not so limited, but rather cover various modifications, and equivalent arrangements, which fall within the purview of the appended claims.

What is claimed is:

1. A plant support device, comprising:
a spool configured to adjustably store and dispense a plant support string;
an escapement mechanism operatively connected to the spool and configured to control a release and retraction of the plant support string; and
a latch mechanism configured to secure the plant support device to a supporting structure or wire.

2. The plant support device of claim 1, wherein the escapement mechanism resists the unwinding of the plant support string due to gravitational force unless a user actively engages the escapement mechanism to release the plant support string.

3. The plant support device of claim 1, wherein the spool comprises one or more ratchet teeth configured to engage with the escapement mechanism.

4. The plant support device of claim 1, wherein the escapement mechanism and the spool comprise a ratchet system, the ratchet system configured to selectively permit the spool to rotate in a first direction while restricting rotation in an opposite direction, thereby controlling the release and retraction of the plant support string.

5. The plant support device of claim 1, wherein the spool comprises a groove formed at a barrel of the spool, and configured to guide and retain the plant support string, preventing the plant support string from slipping off the spool during use.

6. The plant support device of claim 1, wherein the spool further comprises one or more slots configured to allow placement of the plant support string to prevent the plant support string from unwinding when the spool is not within the plant support device.

7. The plant support device of claim 1, wherein the spool further comprises a winding hub configured to integrate with an external mechanical winding apparatus.

8. The plant support device of claim 1, wherein the spool further comprises a hand-winding knob configured to allow a user to manually rotate the spool to wind the plant support string onto the spool.

9. The plant support device of claim 1, wherein the spool is removable from the plant support device to allow for winding, replacement, or adjustment of the plant support string length.

10. The plant support device of claim 1, wherein the spool is mounted on a central axis and is removable by sliding through slots in a body of the plant support device, the escapement mechanism creating a pinch point that must be overcome to insert or remove the spool.

11. The plant support device of claim 1, wherein the latch mechanism includes a hook portion incorporated therein and configured to attach to the supporting structure or wire and ensure the plant support device remains securely attached.

12. The plant support device of claim 1, wherein the latch mechanism is configured to engage by a force of gravity, automatically securing plant support device to the supporting structure or wire, and so as to prevent accidental detachment.

13. The plant support device of claim 3, wherein the escapement mechanism comprises a dual cog system configured to provide redundant engagement with the one or more ratchet teeth of the spool to enhance safety and prevent unintended release.

14. The plant support device of claim 1, wherein the latch mechanism further comprises a secondary locking mechanism configured to engage with the supporting structure or wire to further prevent accidental detachment.

15. The plant support device of claim 5, wherein the spool further comprises a pair of spool flanges extending outward from the barrel to retain the plant support string and prevent lateral displacement.

16. The plant support device of claim 15, wherein the spool flanges further comprise spool edges configured to provide additional retention of the plant support string and reduce a likelihood of slipping.

17. The plant support device of claim 7, wherein the winding hub further comprises a hex attachment point configured to interface with a standard winding tool for efficient manual rewinding of the plant support string, and
the device is constructed with corrosion-resistant fasteners, including at least one of galvanized steel, stainless steel, hot metal riveting, adhesives, and sonic welding.

18. The plant support device of claim 1, wherein the latch mechanism further comprises a pivotally mounted containment latch configured to automatically engage the supporting structure or wire and remain in a locked position until manually released by a user.

19. The plant support device of claim 1, wherein the escapement mechanism is configured to selectively allow a controlled amount of slack in the plant support string, the controlled amount slack enabling height adjustments of a supported plant.

20. The plant support device of claim 1, wherein the spool further comprises at least one notched catchment configured to secure an end of the plant support string in a fixed position when not in use.
